(19) United States
(12) Patent Application Publication
(10) Pub. No.: US 2014/0369559 A1
(43) Pub. Date: Dec. 18, 2014

(54) IMAGE RECOGNITION METHOD AND IMAGE RECOGNITION SYSTEM

(71) Applicant: ASUSTeK COMPUTER INC., Taipei (TW)

(72) Inventors: Kuan-Hsien LIU, TAIPEI (TW); Ding-Chia KAO, TAIPEI (TW)

(21) Appl. No.: 14/303,617

(22) Filed: Jun. 13, 2014

(30) Foreign Application Priority Data
Jun. 18, 2013 (CN) 201310241893.4

(51) Int. Cl. G06K 9/00

(52) U.S. Cl. CPC G06K 9/00536
USPC 382/103

(57) ABSTRACT

An image recognition method includes the following steps: capturing a plurality of images; analyzing the images to get a target object; analyzing the target object to get color information and characteristic information; statistically computing a current image according to the color information and the characteristic information to get a probability distribution map; comparing a difference between the current image and a previous image of the current imago to get dynamic information; and recognizing the target object according to the probability distribution map and the dynamic information.

### CROSS-REFERENCE TO RELATED APPLICATION

This application claims the priority benefit of CN application serial No. 201310241893.4, tiled on Jun. 18, 2013. The entirety of the above-mentioned patent application is hereby incorporated by reference herein and made a part of specification.

### BACKGROUND OF THE INVENTION

1. Field of the Invention

The invention relates to a recognition method and a system and more particularly to an image recognition method and an image recognition system.

2. Description of the Related Art

As technology develops, human-computer interface gradually become intuitive and human friendly. For example, input tools such as a keyboard or a mouse is used in computers, and a touch panel is used in tablets. Nowadays, a gesture recognition technique is developed for the interaction between a user and a computer which is more convenient and intuitive.

A single lens camera has low stability and captures less availability information in gesture recognition. Therefore, a twin lens camera or a single-lens cooperated with an infrared ray camera is currently used in the conventional gesture recognition technique for images capturing.

tIn addition, practically, the conventional gesture recognition method comprises steps of: captures images via a twin lens camera for a single-lens cooperated with an infrared camera) to analyze whether a user hand exists in the image recognizes a static gesture of the hand, and compares the static gesture with gestures in the database. It is time consuming, and the accuracy of the recognition is low.

### BRIEF SUMMARY OF THE INVENTION

A recognition method is provided, it includes the following steps:

capturing a plurality of images; analyzing the images to get a target object; analyzing the target object to get color information and characteristic information; calculating a current image according to the color information and the characteristic information to get a probability distribution map; comparing a difference between the current image and a previous image of the current image to get dynamic information; and recognizing the target object according to the probability distribution map and the dynamic information.

An image recognition system is also provided herein. The image recognition system includes an image acquiring device and a processor, the processor is electrically coupled to the image acquiring device for executing a plurality of instructions, and the instructions include:

analyzing the images to get a target object; analyzing the target object to get color information and characteristic information; calculating a current image according to the color information and the characteristic information to get a probability distribution map; comparing a difference between the current image and a previous image of the current image to get dynamic information; and recognizing the target object according to the probability distribution map and the dynamic information.

An image recognition method and an image recognition system are provided in low cost, time saving while analysis and comparison, and increase the accuracy rate of the recognition.

### BRIEF DESCRIPTION OF THE DRAWINGS

FIG. 1 is a flow chart showing an image recognition method in a first embodiment;

FIG. 2 is a diagram showing an image processed by an image recognition method in a second embodiment; and

FIG. 3 is a diagram showing an image recognition system in a third embodiment.

### DETAILED DESCRIPTION OF THE EMBODIMENTS

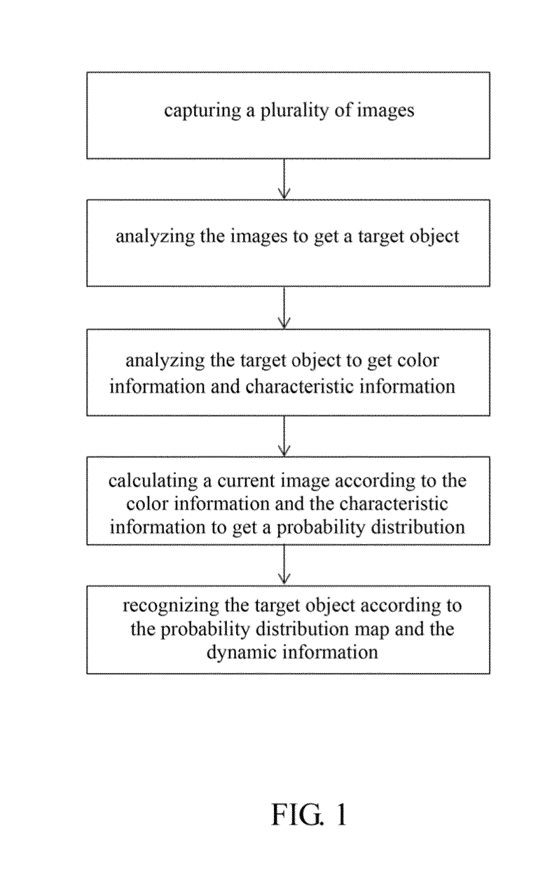

An image recognition method 100 is provided, the steps are shown in FIG. 1, the image recognition method 100 includes the following steps:

step 110: capturing a plurality of images;

step 120: analyzing the images to get a target object;

step 130: analyzing the target object to get color information and characteristic information;

step 140: calculating a current image according to the color information and the characteristic information to get a probability distribution map;

step 150: comparing a difference between the current image and a. previous image of the current image to get dynamic information; and

step 160: recognizing the target object according to the probability distribution map and the dynamic information.

In detail, in the embodiment, the image recognition method 100 is used for recognizing gestures of users, however, the image recognition method 100 can also be adapted to recognize a human face, a car, etc., which is not limited herein.

In an embodiment, the beginning steps 110 to 130 of the above steps are pre-steps to obtain certain information of a user's hand for the subsequent steps, which makes the hand be recognized more simply and correctly.

In detail, a plurality of images are captured in the step 110; the images are analyzed to get the target object in the step 120, for example, movement information and shape information of the images are analyzed to get hand information; pixels of the hand are analyzed to get the color information and the characteristic information in step 130, for instance, the color information may be the color of the hand and the characteristic information may be the palm lines on the hand, further, the characteristic information may be the depth of palm lines, the direction of palm lines and the relative position between different palm lines.

The certain information of the hand is obtained after pre-steps, and the certain information represents the hand in the subsequent steps. In other words, when the color information and the characteristic information exist in the image, which represents that the band appears in the image. However, to recognize the hand in the image more quickly and accurately, please refer to the subsequent steps.

Practically, the images are continually captured, and the current image is recognized continuously as shown in the step 140. First, the current image is statistically computed according to the color information and the characteristic information to get the probability distribution map. The color information and the characteristic information in the image can represent the hand, therefore after the information current image calculated according to the color information and the characteristic information, the probability distribution map of the hand distribution in the image is obtained.

On the one hand, in the step 150, the difference between the current image and the previous image of the current image is compared to get the dynamic information. In detail, when a hand moves, the position of the hand in the current image is different from in that in the previous image, therefore, the difference between the current image and the previous image of the current image can be regarded as the difference of the hand movement, and the difference will be found and regarded as the dynamic information. In other words, the difference is most probably the position of the hand in the image, and the difference can provided as the dynamic information. Furthermore, to get more accurate dynamic information, the comparation can be executed between the current image and a plurality of pervious images (such as ten pervious images) to get the difference.

Then, after the probability distribution and the dynamic information are obtained at the steps 140 and 150, respectively, since they both record the information that the hand has high probability to appear in the image, the intersection of the probability distribution map and the dynamic information are used to recognize the target object in the step 160.

Comparing to the conventional technique, via the step 140, the position of the hand in the image can be preliminarily confirmed more quickly through the probability distribution map. In addition, since only the moving part in the two images is recognized in the step 150, the position of the hand in the image can be confirmed more quickly and accurately, consequently, the hand in the image can be recognized much faster and more accurately according to the image recognition method 100. Moreover, the image recognition method 100 in the embodiment only needs a single image acquiring device, which can further save the cost.

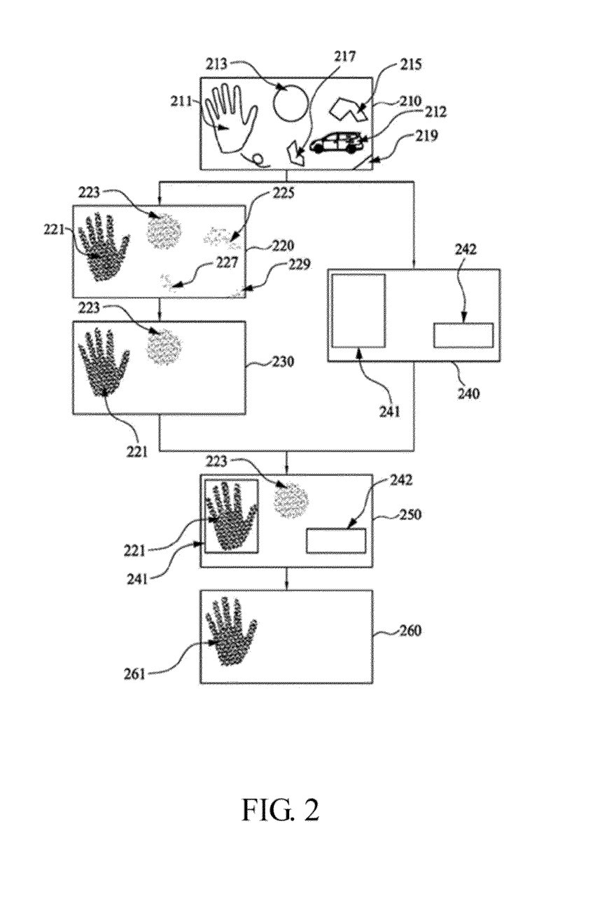

FIG. 2 is a diagram showing an image processed by the image recognition method 100 in a second embodiment. In an embodiment, an image 210 includes a hand 211 and rest object information 212, 213, 215, 217, and 219. Whether each pixel of the image 210 belongs to the hand is statistically computed according to the color information and the characteristic information to get a probability distribution map 220.

In an embodiment, as shown in the image 210 in FIG. 2, except the object 212, the color of the hand 211 and the rest objects 213, 15, 217, 219 are similar. Thus, except the hand 211, the rest objects 213, 215, 217, 219 also have corresponding high probability areas in the probability distribution map 220, such as the high probability areas 221, 221, 225, 227, and 229. The high probability areas represent the area that the hands may appear in the image.

However, as shown in FIG. 2, only the high probability area 221 is the area that the hand appears, therefore, in order to ensure the accuracy of the recognition, the image recognition method 100 further filters high probability areas in the probability distribution map 220 according to morphology. In detail, the hand pattern of an average person is taken as a standard reference for the morphology, such as the size of a hand, the proportion of fingers and palms. Thus, after a filtering is executed at high probability areas in the probability distribution map 220 according to the morphology, high probability areas are filtered out since the size and the proportion of the rest high probability areas does not conform to the morphology standard reference except high probability areas 221 and 223, and the image which has been filtered out according to morphology as shown in the image 230.

The difference between the current image and the previous image is compared in step 150, furthermore, in an embodiment, the current image and the previous images are also compared with a background model to get dynamic information for more accuracy. The dynamic information can refer to the image 240 in FIG. 2. Since the hand 211 and the car 212 move in the image 210, the dynamic information 241, 242 is obtained via the step 150.

Moreover, in an embodiment, please refer to FIG. 2, the intersection of the probability distribution map (such as the image 230) and the dynamic information (such as the dynamic information 241, 242 in the image 240) is computed, and the method of computing the intersection can refer to the image 250. Since the high probability area 221 has intersection with the dynamic information 241, it is conformed as the hand. Further, since the high probability area 223 does not have intersection with the dynamic information 241, 242, the high probability area 223 is filtered out, thus, the hand position 261 can be recognized (please refer to the image 260). In addition, a pattern change or a movement of the hand can be further recognized according to the steps of the image recognition method 100.

In an embodiment, when the pattern change or the movement of the hand of the hand is recognized, a corresponding function is enabled accordingly.

In an embodiment, the image recognition method 100 further includes that the noise of the images is filtered out to increase the accuracy of the image recognition method 100.

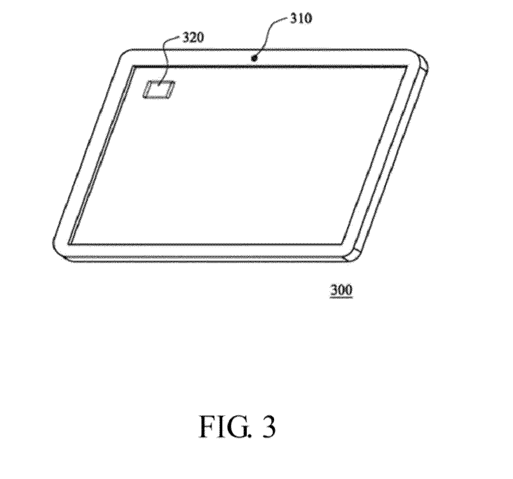

The image recognition method 100 can be accomplished via an image recognition system 300 as shown in FIG. 3 The image recognition system 300 includes an image acquiring device 310 and a processor 320. The processor 320 is electrically coupled to the image acquiring device 310 (not shown). The processor 320 is used for executing a plurality of instructions, and the instructions include:

analyzing the images to get a target object;

analyzing the target object to get color information and characteristic information;

calculating a current image according to the color information and the characteristic information to get a probability distribution map;

comparing a difference between the current image and a previous image of the current image to get dynamic information; and

recognizing the target object according to the probability distribution map and the dynamic information.

It should be noted that those instructions executed by the processor 320 have been described in the image recognition method 100, which are omitted herein for a concise purpose.

Further, the probability distribution map includes a plurality of high probability areas, and the processor 320 of the image recognition system 300 is used for executing the following instructions:

filtering out noise of the images;

statistically computing probability whether each pixel of the current image belongs to the target object according to the color information and the characteristic information to get the probability distribution map;

filtering the high probability areas in probability distribution map according to morphology;

comparing a difference among the current image, the previous image of the current image and a background model to get the dynamic information;

recognizing a pattern change and a movement of the target object according to the probability distribution map and the dynamic information; and

enabling a corresponding function in a computer according to the pattern change and the movement of the target object.

Similarly, the instructions executed by the processor 320 have been described in the image recognition method 100, which are omitted herein for a concise purpose.

The image recognition method 100 can be executed by software, hardware and/or firmware. For example, if considering the execution speed and accuracy first, the hardware and/or firmware can be chosen; if considering the design flexibility first, software can be chosen. Software, hardware and firmware also may be used in cooperation.

Further, the steps of the image recognition method 100 are named according to the function, which is not used for limiting the steps. The steps may be combined into one step, or a step is divided into multiple steps, or a step is replaced b another step, which is not limited herein.

Although the invention has been disclosed with reference to certain preferred embodiments thereof, the disclosure is not for limiting the scope. Persons having ordinary skill in the art may make various modifications and changes without departing from the spirit and the scope of the invention. Therefore, the scope of the appended claims should not be limited to the description of the preferred embodiments described above.

What is claimed is:

1. An image recognition method, comprising:
capturing a plurality of images;
analyzing the images to get a target object;
analyzing the target object to get color information and characteristic information;
calculating a current image according to the color information and the characteristic information to get a probability distribution map;
comparing a difference between the current image and a previous image of the current image to get dynamic information; and
recognizing the target object according to the probability distribution map and the dynamic information.

2. The image recognition method according to claim 1, wherein the probability distribution map includes a plurality of high probability areas, and the image recognition method further includes:
filtering the high probability areas in the probability distribution map according to morphology.

3. The image recognition method according to claim 1, wherein the step of calculating the current image according to the color information and the characteristic information to get the probability distribution map includes:
statistically computing probability whether each pixel of the current image belongs to the target object according to the color information and the characteristic information to get the probability distribution map.

4. The image recognition method according to claim 1, wherein the step of comparing the difference between the current image and the previous image of the current image to get the dynamic information further includes:
comparing a difference among the current image, the previous image of the current image and a background model to get the dynamic information.

5. The image recognition method according to claim 1, comprising:
filtering out noise of the images.

6. The image recognition method according to claim 1, wherein the step of recognizing the target object according to the probability distribution map and the dynamic information includes:
recognizing a pattern change and a movement of the target object according to the probability distribution map and the dynamic information.

7. The image recognition method according to claim 6, comprising:
enabling a corresponding function in a computer according to the pattern change and the movement of the target object.

8. An image recognition system, comprising:
an image acquiring device used for capturing a plurality of images; and
a processor electrically coupled to the image acquiring device and used for executing a plurality of instructions, wherein the instructions include:
analyzing the images to get a target object;
analyzing the target object to get color information and characteristic information;
calculating a current image according to the color information and the characteristic information to get a probability distribution map;
comparing a difference between the current image, a previous image of the current image to get dynamic information; and
recognizing the target object according to the probability distribution map and the dynamic information.

9. The image recognition system according to claim 8, wherein the probability distribution map includes a plurality of high probability areas, the processor is used for executing a plurality of instructions, and the instructions include:
filtering out noise of the images;
statistically computing probability whether each pixel of the current image belongs to the target object according to the color information and the characteristic information to get the probability distribution map;
filtering the high probability areas in the probability distribution map according to morphology;
comparing a difference among the current image, the previous image of the current image and a background model to get the dynamic information; and
computing an intersection between the probability distribution map and the dynamic information to recognize a pattern change and a movement of the target object.

10. The image recognition system according to claim 9, wherein the processor is used for executing an instruction, and the instruction includes:
enabling a corresponding function m a computer according to the pattern change and the movement of the target object.
